(19) United States
(12) Patent Application Publication
(10) Pub. No.: US 2014/0197095 A1
(43) Pub. Date: Jul. 17, 2014

(54) MULTI-LAYER FILTER MATERIAL AND FILTER ELEMENT PRODUCED THEREFROM

(71) Applicants: Andreas Demmel, Feldkirchen-Westerham (DE); Ingrid Meyr, Riemerling (DE); Bernd Klausnitzer, Buckmuhl (DE)

(72) Inventors: Andreas Demmel, Feldkirchen-Westerham (DE); Ingrid Meyr, Riemerling (DE); Bernd Klausnitzer, Buckmuhl (DE)

(73) Assignee: NEENAH GESSNER GmbH, Bruckmuhl (DE)

(21) Appl. No.: 14/236,356

(22) PCT Filed: Feb. 9, 2012
(86) PCT No.: PCT/EP2012/000587

§ 371 Date: Jan. 31, 2014

(30) Foreign Application Priority Data
Aug. 26, 2011 (DE) 10 2011 111 738.9

(51) Int. Cl. B01D 39/16; B01D 29/11; B01D 39/18; B01D 46/52

(52) U.S. Cl. CPC B01D 39/163; B01D 46/52; B01D 29/11; B01D 39/18
USPC 210/491; 55/361; 55/490; 55/492; 55/510; 55/521; 55/524; 55/528; 210/493.5; 210/497.01; 210/498; 210/504; 210/507

(57) ABSTRACT

The invention relates to a multi-layer cleanable filter material for gas and liquid filtration, said filter material comprising a filter layer and a substrate layer that follows the filter layer in the flow direction, wherein the filter layer is substantially dendrite-free and consists of a melt-blown fleece made of elastic polymer fibres that has a breaking elongation of at least 100%.

### FIELD OF THE INVENTION

The invention relates to multi-layer, cleanable filter materials and filter elements produced therefrom for separating off coarse and fine impurities from liquids and gases.

### BACKGROUND OF THE INVENTION

There are essentially two different types of filter materials for removal of solid impurities, such as, for example, dust particles, from liquids and gases.

One type comprises deep-bed filters which are constructed such that they can absorb and store as much dust as possible before they become blocked. Such filter materials ideally have an asymmetric structure, that is to say the pore and fibre diameters become ever smaller viewed in the direction of flow. This leads to the large dust particles being preferably collected and embedded in the top layer of the deep-bed filter material, while the small dust particles advance further into the depth of the material before they are also collected. Due to this distribution of the dust particles in the entire depth of the filter material, a relatively large amount of dust can be embedded before the flow of liquid or gas is so severely impeded by the embedded dust particles that blocking of the filter material occurs. These filters cannot be cleaned and must be dismantled and discarded after a given pressure difference is reached.

The second type comprises surface filter materials. In these filter materials the first filtration layer viewed in the direction of flow has the smallest pore and fibre diameters. The following layer is usually open-pored and has thicker fibres. It serves chiefly as a carrier for the first filtration layer and imparts to the entire filter material the required mechanical strength and rigidity. All dust particles, regardless of whether they are large or small, are ideally collected on the first layer and do not penetrate into the filter material. As a result, a dust cake forms on the surface of the filter material over time, and ever more impedes the flow of liquid or gas. Since the dust cake sits quite loosely on the surface of the filter material, it can also be cleaned off again relatively easily. Cleaning is ideally carried out either by beating, shaking, washing, pressure shock pulsing or backwashing. During backwashing and during pressure shock pulsing the filter material is briefly charged with clean liquid or clean gas against the original direction of flow. As a result, the dust cake is detached from the surface of the filter material and the filter material cleaned in this way is ready for the next filtration cycle. In the case of backwashing, this is carried out over a relatively long period of time with a relatively low flow rate of the cleaning fluid, whereas in the case of pressure shock pulsing the material is charged with the cleaning liquid in a short, powerful shock.

Filter materials for surface filtration are either single- or multilayered in structure. Single-layer surface filter materials are, for example, filter papers, which have smaller pores on the inflow side than on the outflow side, or needle felts or spunbonded nonwovens compressed on one side. A spunbonded nonwoven compressed on one side is described by way of example in the publication DE 10 039 245 A1. In spite of surface compression on one side, the single-layer filter materials still have relatively large pores on the compressed side and are suitable only for quite coarse-grained dusts. Finer dust particles penetrate into the depth of the filter material and can no longer be cleaned off. As a result the filter material becomes blocked after a relatively short time and must be replaced.

Filter materials having an at least two-layered structure are used for collection of fine dusts, such as, for example, dye powders, ground resins or cement. Either a membrane, a nanofibre layer or a meltblown layer is applied as the filtration layer to a carrier having a high mechanical strength and rigidity. The filtration layer is the first layer viewed in the direction of flow.

A filter material having a PTFE membrane is described for example in the journal CAV 12/92 (p. 86). Such filter materials are very well suited for collection of fine dusts, also at high temperatures. The cleaning properties with respect to all types of dusts are exceptionally good. Nevertheless, these filter materials are very expensive and the membrane tears very easily and is not particularly wear-resistant.

The European patent EP 1 326 698 B1 describes by way of example a filter material having a nanofibre layer. The nanofibres are produced in the electrostatic spinning process. The filter material disclosed in this specification is likewise suitable for collection of fine dusts. It has similarly good cleaning properties. Due to the small layer thickness of less than 10 μm and the very low fibre diameters of 0.01-0.5 μm, the nanofibre layer is not properly stable mechanically and can easily be destroyed. Furthermore, the entire filter material is very expensive due to the low productivity of the electrostatic spinning process.

An example of a filter material having a meltblown layer is described in DE 44 431 58 A1. The advantage of these filter materials is the comparatively low price. Nevertheless, here also the not very high mechanical strength of the meltblown layer is a disadvantage.

The use of meltblown nonwovens as filter materials has been known for a long time. The meltblown process is described in more detail for example in A. van Wente, “Superfine Thermoplastic Fibers”, Industrial Engineering Chemistry, vol. 48, p. 1342-1346. Essentially continuous fibres having a diameter of 0.3-15 μm can be produced by this process. The lower the fibre diameter and the more densely the fibres lie alongside one another, the better suited the meltblown nonwoven is for collection of fine dusts from gases and liquids. Unfortunately, however, the mechanical strength of the fibres also falls with the fibre diameter. Whenever the meltblown nonwoven produced in this way is exposed to a mechanical load, such as for example when a finger is rubbed over the surface or when the filter material is folded during later production of the filter element, some fibres break and dendrites are formed. Dendrites are to be understood as meaning torn meltblown fibres of varying length which protrude from the surface of the meltblown nonwoven at an angle of from 10° to 90°. Since the filter material is usually folded further during production of a filter element, the dendrites project into the otherwise free space of the inflow side. Protrusion of the dendrites from the surface of the meltblown nonwoven is intensified further when the meltblown nonwoven becomes electrostatically charged. Filter elements having such filter materials of meltblown nonwovens already tend to become blocked after a short time, with the consequence that the filter element has to be replaced.

As described in DE 44 431 58 A1 and DE 10 039 245 A1, the mechanical strength and the surface smoothness can be improved by thermal compression of the surface by means of a calender. However, a compression of the surface which significantly increases the mechanical strength of the meltblown nonwoven simultaneously adversely influences the porosity and permeability to air. The thermal compression moreover represents an additional process step. DE 44 431 58 A1 further discloses that the meltblown nonwoven can be consolidated by itself or together with a carrier with a binder in order to increase the resistance to attrition and abrasion. However, this process again has an adverse effect on the permeability of the filter material to air and represents a further, expensive process step.

There is therefore an urgent need for a filter material which does not have the disadvantages described above.

### SUMMARY OF THE INVENTION

The object of the present invention is therefore to provide a filter material, in particular for motor vehicle, vacuum cleaner and industrial filters, which has a very good collection efficiency according to EN 779 and ISO EN 1822 in filter classes F5 to H12 and can be very readily cleaned. A filter element produced from such a filter material is furthermore to be provided.

This object is achieved according to the invention by the features of claims 1 and 12. Advantageous embodiments of the invention are described in the further claims.

### DETAILED DESCRIPTION OF THE INVENTION, EMBODIMENTS

The first layer of the filter material viewed in the direction of flow is made of a meltblown nonwoven which is at least essentially free from dendrites. This is achieved in that the meltblown nonwoven is made of elastic polymer fibres and has an elongation at break according to DIN EN ISO 1924-2 of at least 100%, the polymer for the production of the elastic polymer fibres having an elongation at break at 23±2° C. according to DIN 53504 of at least 100%. It has been found that without such dendrites the cleanability of meltblown nonwovens which are made of fine fibres is improved considerably. This is attributed to the fact that in the filtration operation dust particles can settle particularly readily on the dendrites and form a dust cake which, in particular by backwashing or compressed air shock, can be cleaned off only incompletely. Without such dendrites, on the other hand, a considerably smoother surface of the meltblown nonwoven is created, on which the adhesion of the dust cake is considerably poorer.

The absence of dendrites is achieved by a suitable choice of polymer. Suitable polymers are preferably thermoplastic elastomers or mixtures of thermoplastic elastomers with non-elastic thermoplastic polymers. Thermoplastic elastomers and mixtures of thermoplastic elastomers with non-elastic thermoplastic polymers which have antistatic properties are particularly preferred. The thermoplastic elastomers or mixtures of thermoplastic elastomers and non-elastic thermoplastic polymers which are suitable for the production of the filter material according to the invention have an elongation at break according to DIN 53504 of at least 100%, preferably of at least 200% and particularly preferably of at least 400%. The measurement according to DIN 53504 is carried out at room temperature (23±2° C.) on dumbbell specimens of the S1 or S2 type. Before measurement, the dumbbell specimens are climatically controlled at 23±2° C. and 50±2% atmospheric humidity for 24 hours. Due to the high elasticity, the mechanical forces such as arise for example through friction are taken up and absorbed by the fibres. Instead of tearing, the fibres extend and essentially resume their original shape after the action of force has ended. As a result, there are also no changes in the porosity and in the permeability to air.

In further studies it has been found that fibres of thermoplastic elastomers or mixtures of thermoplastic elastomers and non-elastic thermoplastic polymers which have antistatic properties and therefore cannot be electrostatically charged offer a further advantage. Should tearing of the fibres nevertheless occur in spite of the high elasticity, the fibre ends essentially remain lying on the nonwoven surface and do not protrude from the nonwoven surface due to electrostatic repulsions. Either the polymer used is antistatic per se, such as for example thermoplastic polyurethane, or the polymer acquires antistatic properties by the addition of a suitable agent. Suitable antistatic agents are for example carbon black and quaternary ammonium salts.

Suitable thermoplastic elastomers are for example thermoplastic polyurethane, olefinic thermoplastic elastomer, styrene block copolymer, thermoplastic polyester elastomer, thermoplastic polyether-polyamide or mixtures thereof.

Suitable non-elastic thermoplastic polymers for mixing with thermoplastic elastomers are for example polypropylene, polybutylene terephthalate, polyethylene terephthalate, polyamide, polycarbonate or mixtures thereof.

The meltblown process known in technical circles such as is described for example in A. van Wente, “Superfine Thermoplastic Fibers”, Industrial Engineering Chemistry, vol. 48, p. 1342-1346, is used for production of the meltblown nonwovens.

Preferably, the meltblown nonwoven has a weight per unit area of 5-200 g/m², a permeability to air of 10-8000 l/m²/s, a thickness of 0.05-2.0 mm, an elongation at break of at least 100%, an average fibre diameter of 0.3-12 μm, a cleaning efficiency after 10040 cycles of at least 80%, a pressure loss after 10040 cycles of at most 600 Pa after cleaning and a total time for 10070 cycles of at least 2000 min, preferably a weight per unit area of 10-150 g/m², a permeability to air of 20-4000 l/m²/s, a thickness of 0.08-1.5 mm, an elongation at break of at least 200%, an average fibre diameter of 0.3-10 μm, a cleaning efficiency after 10040 cycles of at least 85%, a pressure loss after 10040 cycles of at most 400 Pa after cleaning and a total time for 10070 cycles of at least 2100 min, and particularly preferably a weight per unit area of 15-100 g/m², a permeability to air of 20-2500 l/m²/s, a thickness of 0.1-1.0 mm, an elongation at break of at least 300%, an average fibre diameter of 0.3-8 μm, a cleaning efficiency after 10040 cycles of at least 90%, a pressure loss after 10040 cycles of at most 300 Pa after cleaning and a total time for 10070 cycles of at least 2200 min.

The further, in particular second layer of the filter material according to the invention is a carrier layer for the first layer. The carrier layer is essentially non-extendable and more open-pored and permeable to air than the first layer. It therefore contributes only insignificantly towards the dust collection. Its task is to give the filter material according to the invention the required tear strength and rigidity. How high the tear strength has to be depends on the intended use of the filter material. However, it must always be high enough so that the filter material does not tear and does not deform under the given use conditions. If the filter material is to be folded for its use, a carrier layer which is as rigid as possible, such as for example a paper impregnated with resin, is to be chosen so that the folds also retain their shape during the given operating conditions. The person skilled in the art knows to search for the optimum carrier for the given intended use from the large number of carriers available. Suitable carrier layers are for example impregnated papers of cellulose fibres, inorganic fibres, carbon fibres, synthetic fibres or mixtures thereof, spunbonded nonwovens, needle felts, woven fabric of glass fibres or synthetic fibres, mesh structures (woven, extruded) and any combination of the materials mentioned here.

The carrier layer mentioned preferably has the following physical properties:
Weight per unit area: 20-1000 g/m²
Thickness: 0.05-60 mm
Mullen bursting strength: greater than 100 kPa
Permeability to air: 10-8,000 l/m2/s

Elongation at break according to DIN EN ISO 1924-2 at a take-off speed of 100 mm/min depending on the material: between 1% (wet-laid cellulose-containing carrier) and 40% (synthetic carrier, configured as needle felt, spunbonded nonwoven, woven fabric)

To increase the strength or the rigidity, the filter material according to the invention can also comprise a third layer. The third layer is a support mesh which either forms the last layer viewed in the direction of flow or is positioned between the first layer (meltblown nonwoven) and the further layer (carrier layer). Suitable support meshes are for example meshes of plastic, metal meshes, spunbonded nonwovens, glass fibre woven fabric, glass fibre nonwoven having weights per unit area of between 5 and 75 g/m² and a minimum permeability to air of 100 l/m².

All the layers of the filter material according to the invention are preferably bonded to one another either with an adhesive or via welded bonds or a combination thereof.

Suitable adhesives for this use are for example polyurethane adhesives, polyamide adhesives and polyester adhesives, polyacrylate adhesives, polyvinyl acetate adhesives or styrene block polymer adhesives. In this context polyurethane adhesives which crosslink with moisture from the atmosphere are particularly preferred. The adhesives can be applied as powder or in molten form by means of screen rollers or spray nozzles. If the adhesive is applied as powder, the adhesive must subsequently be melted by a heat treatment. In this context the adjacent layers of the filter material according to the invention are then bonded to one another under pressure. If the adhesive is applied via screen rollers or spray nozzles, it is already present in liquid form, either molten or as a solution or dispersion, before the spraying. Application via spray nozzles can be carried out in the form of fine droplets or in the form of threads. In this process also the adjacent layers of the filter material according to the invention are subsequently bonded to one another by pressure. The weight of adhesive applied is typically between 2-20 g/m², preferably between 4-15 g/m² and particularly preferably between 5-10 g/m².

The welded bond can be effected both by an ultrasound installation and by a thermocalender. In this context the polymers of the layers to be welded are melted in regions and welded to one another. In this context the welded bonds can have any desired geometric shapes, such as for example points, straight lines, curved lines, lozenges, triangles etc. The area of the welded bonds is advantageously at most 10% of the total area of the filter material according to the invention.

The filter material according to the invention can be further processed to all the conventional element forms. Thus for example tubes, pouches or bags can be produced therefrom. Alternatively, it can be embossed, folded, corrugated in the transverse direction, grooved in the longitudinal direction etc. on all the conventional processing machines.

As already described, the filter material according to the invention and the filters produced therefrom can be very readily cleaned for increasing their life. Suitable cleaning processes are for example washing off, backwashing, beating off, shaking off and pressure shock pulsing.

### Description of the Test Methods

Elongation at break unless stated otherwise according to DIN EN ISO 1924-2 at a take-off speed of 100 mm/min, specimen width of 50 mm, clamped length of 100 mm
Weight per unit area according to DIN EN ISO 536
Thickness according to DIN EN ISO 534
Permeability to air according to DIN EN ISO 9237 under a 200 Pa pressure difference
Cleaning efficiency according to VDI ISO 3926
Average fibre diameter by means of the SEM method, Phenom apparatus from FEI in combination with FEI Fibermetric evaluation software
Mullen bursting strength according to DIN 53141

The measurement of the weight per unit area, thickness, permeability to air, bursting strength and elongation at break is carried out on specimens which have been climatically controlled at 23±2° C. and 50±2% relative atmospheric humidity for 24 hours before the measurement. The measurement itself is performed at room temperature (23±2° C.).

### EXAMPLE 1

The screen side of a carrier layer was glued to the screen side of an upper layer made of a meltblown nonwoven. The meltblown nonwoven was made of a thermoplastic polyurethane produced from the raw material Elastollan from BASF, and had an average fibre diameter of 2.2 μm, a weight per unit area of 20 g/m², a permeability to air of 800 l/m²/s, a thickness of 0.2 μm and an elongation at break of 220%. The carrier layer was made of wet-laid cellulose impregnated with 20% of epoxy resin from Huntsman with a weight per unit area of 122 g/m², a permeability to air of 210 l/m²/s and a bursting pressure of 290 kPa. The carrier layer can be obtained under the name L4-2iHP from Neenah Gessner GmbH, Bruckmuhl. The two layers were glued to one another with a moisture-crosslinking polyurethane hot-melt adhesive of the PUR 700.7 type from Kleiberit. The application was carried out via a spray nozzle in the form of filaments with an application weight of 6.0 g/m². The entire filter material had a weight per unit area of 148 g/m², a thickness of 0.58 mm and a permeability to air of 166 l/m²/s. This filter material was measured as a flat specimen according to VDI ISO 3926. The results can be seen from Table 1, Example 1.

### EXAMPLE 2 (COMPARATIVE EXAMPLE)

The screen side of a carrier layer was glued to the screen side of an upper layer made of a meltblown nonwoven. The meltblown nonwoven was made of a polybutylene terephthalate produced from the raw material Cellanex 2008 from Ticona, and had an average fibre diameter of 2.0 μm, a weight per unit area of 20 g/m², a permeability to air of 760 l/m²/s, a thickness of 0.18 μm and an elongation at break of 25%. The carrier layer was made of wet-laid cellulose impregnated with 20% of epoxy resin from Huntsman with a weight per unit area of 122 g/m², a permeability to air of 210 l/m²/s and a bursting pressure of 290 kPa. The carrier layer can be obtained under the name L4-2iHP from Neenah Gessner GmbH, Bruckmuhl. The two layers were glued to one another with a moisture-crosslinking polyurethane hot-melt adhesive of the PUR 700.7 type from Kleiberit. The application was carried out via a spray nozzle in the form of threads with an application weight of 6 g/m². The entire filter material had a weight per unit area of 148 g/m², a thickness of 0.56 mm and a permeability to air of 165 l/m²/s. This filter material was measured as a flat specimen according to VDI ISO 3926. The results can be seen from Table 1, Example 2.

TABLE 1

| | | Example 2 |
|---|---|---|
| | | (comparative |
| | Example 1 | example) |
| Cleaning efficiency after cycle 30 | 95.5% | 77.5% |
| Cleaning efficiency after cycle 10040 | 91.7% | 78.9% |
| Cleaning efficiency after the last cycle (10070) | 91.4% | 74.6% |
| Pressure loss after 10040 cycles | 261 Pa | 301 Pa |
| Total time for 10070 cycles | 2252.34 min | 1980.77 min |

As can be seen from Table 1, the filter element from the filter material according to the invention (Example 1) can be cleaned in all measurement criteria significantly better than the filter material with a conventional PBT meltblown layer (Example 2).

1-17. (canceled)

18. Cleanable filter material comprising a cleanable first layer of a meltblown nonwoven and a further layer which forms a carrier layer, wherein the meltblown nonwoven is made of elastic polymer fibres, characterised in that the elastic polymer fibres are made of thermoplastic elastomers or of mixtures of thermoplastic elastomers and non-elastic polymers, wherein the polymer for the production of the elastic polymer fibres has an elongation at break according to DIN 53504 of at least 100% at 23±2° C., and in that the meltblown nonwoven has an elongation at break according to DIN EN ISO 1924-2 of at least 100%, a weight per unit area of 5-200 g/m², a thickness of 0.05-2.0 mm, a permeability to air of 10-8000 g/m²/s and an average fibre diameter of 0.3-12 μm.

19. Filter material according to claim 18, wherein the meltblown nonwoven of the first layer is made of a thermoplastic, elastic polymer chosen from the group of thermoplastic polyurethanes, olefinic thermoplastic elastomers, styrene block copolymers, thermoplastic polyester elastomers and thermoplastic polyether-polyamides.

20. Filter material according to claim 18, wherein the meltblown nonwoven of the first layer is antistatic.

21. Filter material according to claim 18, wherein the carrier layer is made of a wet-laid or dry-laid nonwoven of cellulose fibres or synthetic fibres or inorganic fibres or carbon fibres or a mixture thereof.

22. Filter material according to claim 18, wherein the carrier layer has a weight per unit area of 20-1000 g/m², a thickness of 0.05-60 mm, a permeability to air of 10-8000 l/m²/s and a bursting strength of at least 100 kPa.

23. Filter material according to claim 18, wherein the filter material has a further layer forming a support mesh, wherein the support mesh is arranged between the meltblown nonwoven and the carrier layer or behind the carrier layer viewed in the direction of flow.

24. Filter material according to claim 23, wherein the support mesh forms the last layer viewed in the direction of flow.

25. Filter material according to claim 23, wherein the support mesh is a mesh of plastic, a metal mesh, a spunbonded nonwoven, a glass fibre nonwoven or a glass fibre woven fabric.

26. Filter material according to claim 18, wherein all the layers are bonded to one another by gluing and/or welding.

27. Filter element produced using a filter material according to claim 18.

28. Filter element according to claim 27, wherein the filter material is shaped as a bag, pouch or tube.

29. Filter element according to claim 27, wherein the filter material is folded and/or embossed.

30. Filter element according to claim 27, wherein the filter material is grooved in the longitudinal direction.

31. Filter element according to claim 27, wherein the filter material is corrugated in the transverse direction.
